(19) United States
(12) Patent Application Publication
(10) Pub. No.: US 2016/0205916 A1
(43) Pub. Date: Jul. 21, 2016

(54) SHEET FOR CONTROLLING TERMITES

(71) Applicant: National Institute of Forest Science, Seoul (KR)

(72) Inventors: Wonjoung HWANG, Chuncheon-si (KR); Dongheub LEE, Seoul (KR); Jinyoung CHUNG, Seoul (KR); Geumman KANG, Seoul (KR)

(73) Assignee: National Institute of Forest Science, Seoul (KR)

(21) Appl. No.: 15/002,765

(22) Filed: Jan. 21, 2016

(30) Foreign Application Priority Data
Jan. 21, 2015 (KR) 10-2015-0009959

(51) Int. Cl. A01M 1/20

(52) U.S. Cl. CPC A01M 1/2011

(57) ABSTRACT

The present invention relates to a sheet for controlling termites, and more particularly, a sheet for controlling termites which has excellent control effect, can be easily treated and installed and is capable of prevent the place on which the sheet is installed from being damaged and deformed. The sheet for controlling termites according to the present invention comprises, a sheet main body being installed on the mounting surface and having planar structure; a movement route of termites being formed in the sheet main body for movement of termites; and a layer of termite pesticide comprising termite pesticide composition and being formed in the sheet main body and the movement route of termites.

### BACKGROUND

1. Field

The present invention relates to a sheet for controlling termites, and more particularly, a sheet for controlling termites which has excellent control effect, can be easily treated and installed and is capable of prevent the place on which the sheet is installed from being damaged and deformed.

2. Description of the Related Art

Generally, wooden structures are damaged directly or indirectly from several factors of natural environment. However, recently the damage to wooden structures caused by insects is due to the fact that the insects eat the wooden structure as nutrients.

The insects damaging wooden structures include six kinds of Isoptera, Coleoptera, Thysanura, Blattaria and Hymenoptera, and especially in Korea the damages from Isoptera, Coleoptera and Hymenoptera are observed noticeably.

And as a termite which is a representative of insects damaging wooden structure eats a pillar of a wooden structure and other structural material to give damage to the structure, it terminates the life of the structure and causes the structural instability of the structure.

Most of termites that live in Korea are Reticulitermes speratus, a kind of a subterranean termite. Reticulitermes speratus is found throughout Korea, for example Seoul, Gyeonggi, Gangwon and north part of South Korea. Generally, once damage from termites occurs, although change from the damage cannot be found outside, the cavitation phenomenon appears inside the wooden structure.

Recently as for Reticulitermes speratus living in Korea, their population has increased significantly to give more damage to wooden structures, et al., and their distribution range has widened. So the phenomena are a sign of spread of termites. In ecological aspects, a termite has characteristics similar to a cockroach. Once termites have obtained their habitat under the ground or inside a wood, they become extremely difficult to control. They mostly live under the ground and inside the wood, and move inside underground tunnel or on the ground. Therefore, after the damage was revealed outside to be checked by eyes, it is most likely that significant damage has already progressed.

According to the result of investigation by the Cultural Heritage Administration, 78 out of 231 wooden cultural properties of 16 places (33.8%) have been damaged. Also it was investigated that 43% of national treasure structures have been damaged in Japan.

In order to solve the above problem caused by the damage from termites, various research and development activities have been progressed all around the world. For example, Korean Patent Publication No.10-1996-0000019(publication date: Jan. 25, 1996) proposed a termites alarm device for detecting intrusion of termites. However, as the device could only detect intrusion of termites, it has a limit of not being able to control termites substantially.

Also, Korean Patent Publication No.10-2010-0029842(publication date: Mar. 17, 2010) proposed the technique regarding ground termites station shown in FIG. 1.

The ground termites station is for detecting and controlling termites on the ground. The station is formed as a container with inside space, and at least a part of the container is mounted to be attached on the ground. The container of the station may be closed form or open form which allows to access to the inside space while being mounted on the ground. A cartridge has such a size and configuration that it can be inserted into and separated from the inside space. Generally, the cartridge comprises a gathering members, a bait matrix independent from the gathering members and a holder, wherein the holder is assembled with the gathering members and the bait matrix to hold at least a part of them and consequently the cartridge can be placed on the inside space of the container as a single unit.

The ground termites station is somewhat effective for detection and control of termites. However, it has too big size to be treated and be installed conveniently, and it is difficult to respond properly to satisfy complex structural characteristics of wooden structures. Also it is impossible to block the various entry routes of termites completely. Therefore, there is a limit that it cannot control completely, and consequently has a low control effect. In particular, in case of installing it on old structures such as wooden cultural properties, there is disadvantage that it causes damage and deformation to wooden structures and then gives serious adverse effect on their durability.

### SUMMARY

The present invention aims to provide a sheet for controlling termites having excellent effect of controlling termites, being easily treated and installed and preventing the place on which the sheet is installed from being damaged and deformed.

In order to achieve the above object, a sheet for controlling termites according to the present invention comprises, a sheet main body being installed on the mounting surface and having planar structure; a movement route of termites being formed in the sheet main body for movement of termites; and a layer of termite pesticide comprising termite pesticide composition and being formed in the sheet main body and the movement route of termites.

Preferably, the sheet main body consists of a planar body made of paper and fabric, and a linear member fixed to be placed on the planar body, and the movement route of termites is the gap formed between the planar body and the linear member.

The linear member may consist of inorganic or organic fiber yarns, and be attached to the planar body by adhesive.

In order to achieve the above object, a sheet for controlling termites according to the present invention comprises, a sheet main body being installed on the mounting surface and having planar structure; a movement route of termites being formed in the sheet main body for movement of termites; and a layer of termite pesticide comprising termite pesticide composition and being formed in the sheet main body and the movement route of termites, wherein the sheet main body may be made of paper or fabric, and the movement route of termites may be groove-like passage formed to be concave linearly on the sheet main body.

The groove-like passage may comprise a narrow passage with narrow width and a wide passage with wider width than the narrow passage.

In addition, the groove-like passage may comprise more than one of bent portions.

According to a sheet for controlling termites according to an embodiment of the present invention, the sheet has an effect to improve control efficiency in that because the sheet main body is made of thin paper such as traditional Korean paper, the sheet can be installed to be attached to the wooden materials, also surround wooden materials to block the entry routes of termites completely and lure termites into the sheet main body through a movement route of termites to control them.

In addition, a sheet for controlling termites according to the present invention has an advantage that because it is made of paper, it can have a small size, be easily treated and installed and be attached while not giving damage to complex wooden structures. In particular, in case of installing the sheet on old structures such as wooden cultural properties, it has an advantage of preventing the structures from being damaged and deformed totally as well as being able to control termites conveniently.

### BRIEF DESCRIPTION OF THE DRAWINGS

FIG. 1 is a drawing illustrating a conventional sheet for controlling termites,

FIG. 2 is a schematic perspective view of a sheet for controlling termites according to an embodiment of the present invention,

FIG. 3 is a photograph substituting a drawing of the product produced from the drawing for illustrating a sheet for controlling termites according to an embodiment of the present invention,

As FIGS. 4A to 4C are drawings for explaining the operation of a sheet for controlling termites according to an embodiment of the present invention, FIG. 4A is a drawing of illustrating a test device which the sheet for controlling termites is installed on,

FIGS. 4B and 4C are photographs substituting drawings of enlarging main portions of the sheet for controlling termites after test.

FIG. 5 is a perspective view of a sheet for controlling termites according to another embodiment of the present invention.

FIG. 6 is a perspective view of a sheet for controlling termites according to a modified embodiment of the present invention.

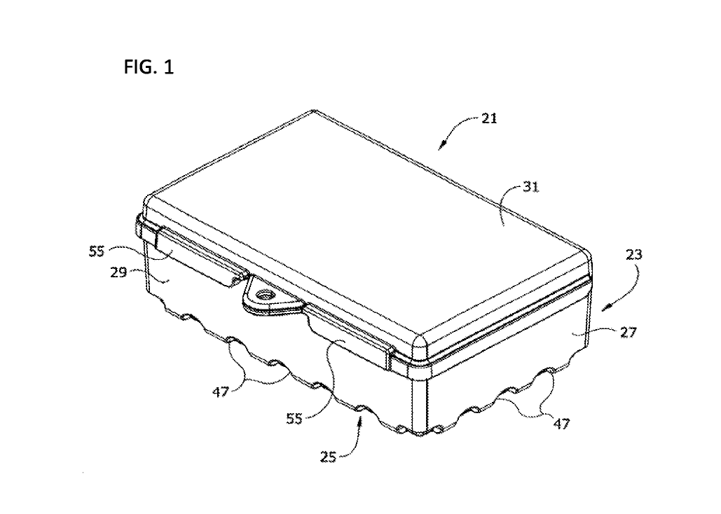

1, 1′, 1″: sheet for controlling termites 11: sheet main body

111: planar body

112: linear member

12, 12′: movement route of termites

121: narrow passage

122: a wide passage

123: bent portion

a: the place on which the sheet is installed

b: test device

s: termite

### DETAILED DESCRIPTION OF EXEMPLARY EMBODIMENTS

Hereinafter, an embodiment of the present invention would be explained in detail referring to appended drawings.

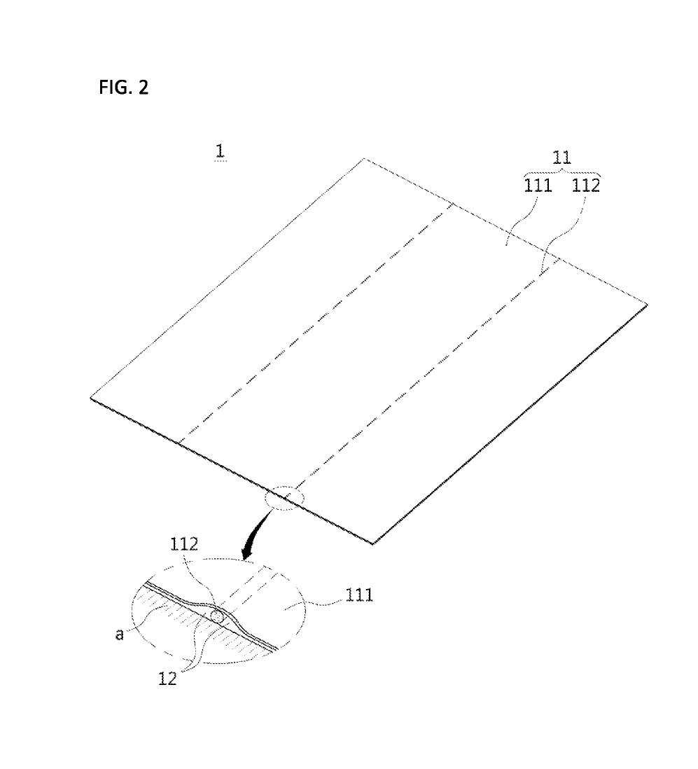

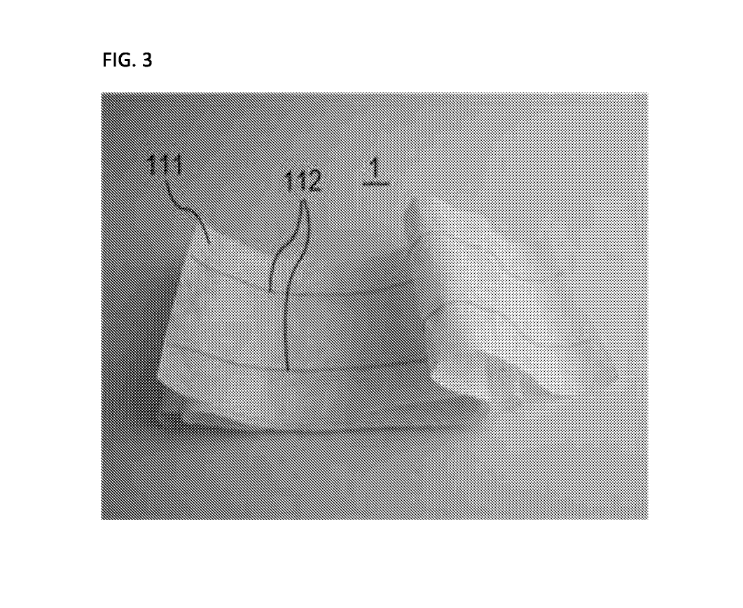

FIG. 2 is a schematic perspective view of a sheet for controlling termites according to an embodiment of the present invention, and FIG. 3 is a photograph substituting a drawing of the product produced from the drawing for illustrating a sheet for controlling termites according to an embodiment of the present invention.

Referring to FIGS. 2 and 3, a sheet for controlling termites 1 according to an embodiment of the present invention comprises a sheet main body 11 being installed in the mounting surface (a) such as wood and having planar structure, a movement route of termites 12 being formed in the sheet main body 11 for movement of termites, and a layer of termite pesticide(not shown) comprising termite pesticide composition and being formed in the sheet main body 11 and the movement route of termites 12.

The sheet main body 11 consists of a planar body 111 and a linear member 112 fixed to be placed on the planar body 111. Any sheet having planar structure can be used as the planar body 111 without limitation, for example paper such as traditional Korean paper, fabric such as knitted fabric or weaved fabric, and synthetic resin sheet such as vinyl sheet.

In addition, the linear member 112 consists of inorganic or organic fiber yarns, and is attached to the planar body 111 by adhesive. Here, it is possible to use various types of adhesives, if they would have excellent adhesiveness and not be avoided by termites.

On the other hand, the movement route of termites 12 may be formed by producing a separate movement route and then attaching it to the sheet main body 11. However, in this embodiment of the present invention, two gaps are formed on the bottom surface of the planar body 111 of both sides of the linear members 112 by attaching the linear members 112 to the planar body 111 having planar structure and then the two gaps are used as the movement route of termites 12.

The layer of termite pesticide (not shown) is formed by coating or dipping with termite pesticide composition. Any termite pesticide composition can be used without limitation if it has effective insecticidal properties. However in this embodiment of the present invention, the layer of termite pesticide (not shown) is formed by adding bistrifluron to alcohol as a solvent to make 2 w/v % solution, and then dipping the sheet main body 11 to the solution.

Hereinafter, operation of the sheet for controlling termites according to an embodiment of the present invention is briefly described.

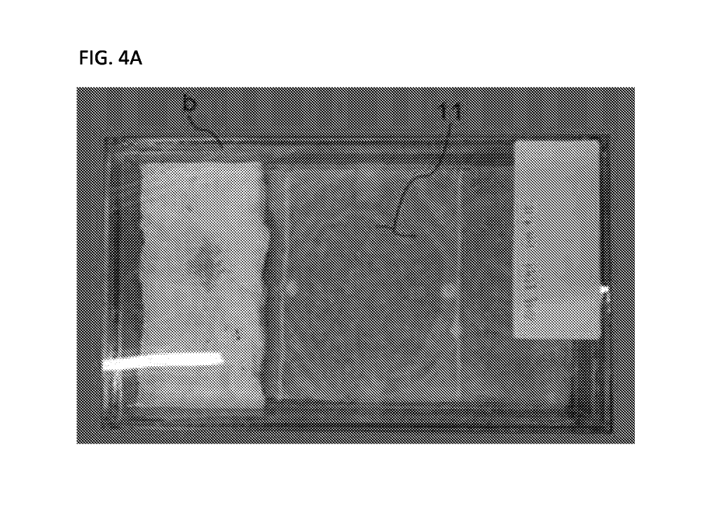

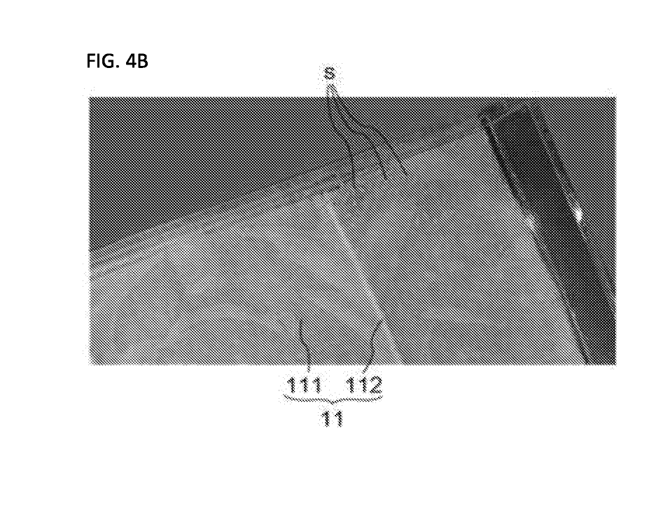

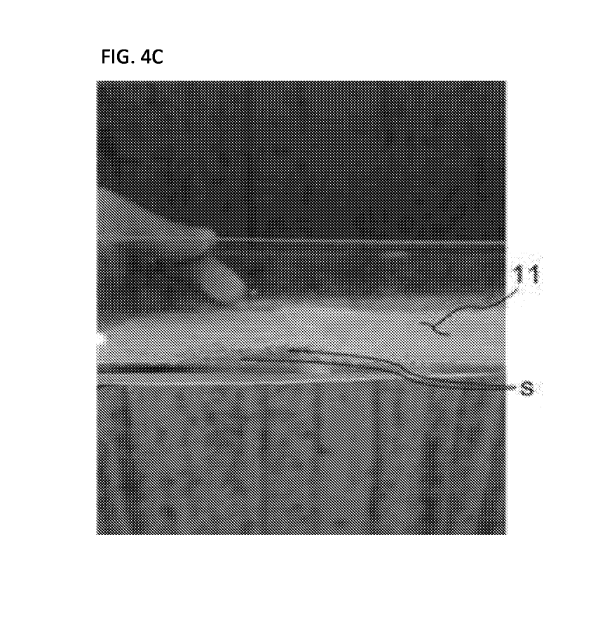

FIGS. 4A to 4C are drawings for explaining the operation of a sheet for controlling termites according to an embodiment of the present invention. FIG. 4A is a photograph substituting drawing of showing a test device which the sheet for controlling termites is installed on, FIGS. 4B and 4C are photographs substituting drawings of enlarging main portions of the sheet for controlling termites after test. Here FIG. 4B is showing the shape shown on plane and FIG. 4C is showing the shape shown on side.

First, as shown in FIG. 3, traditional Korean paper is cut into a rectangular shape to produce the planar body 111, and then the linear members 112 are attached to the planar body 111 by adhesive.

After, the layer of termite pesticide (not shown) is formed by adding bistrifluron to alcohol as a solvent to make 2 w/v % solution, and then dipping the sheet main body 11 to the solution.

As shown in FIG. 4A, experiment of attaching the sheet for controlling termites 1 produced by the above embodiment to bottom of test device (b) made of acryl and then putting Reticulitermes speratus into the sheet 1 was conducted. As a result, as shown in FIGS. 4B and 4C, it was found that the termites moved to the movement route of termites 12 formed by the linear members 112 and then died.

Hereinafter, another embodiment according to the present invention is described. However, a detailed description same or similar components as the embodiment described above will be skipped, and different components will be mainly described.

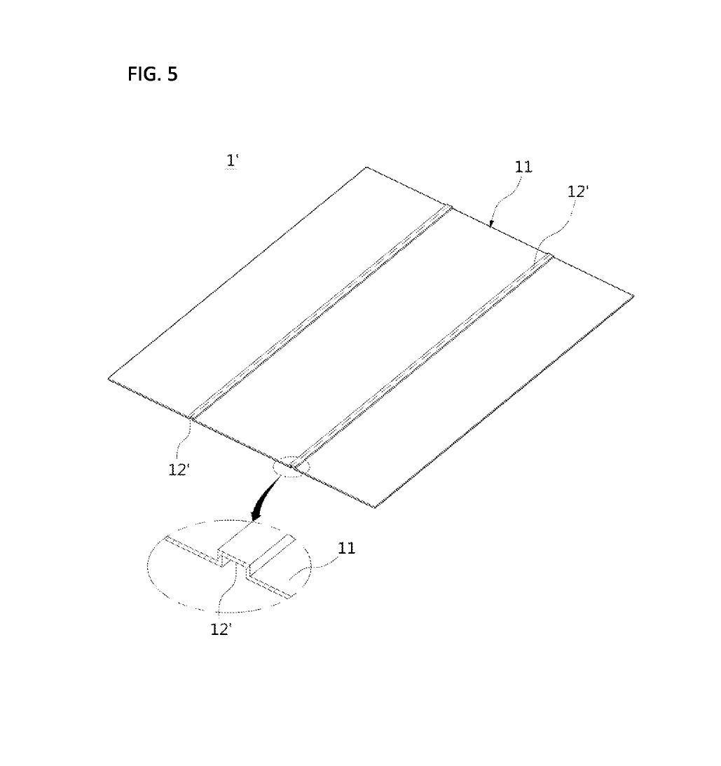

FIG. 5 is a perspective view of a sheet for controlling termites according to another embodiment of the present invention.

Referring to FIG. 5, a sheet for controlling termites 1′ according to another embodiment of the present invention comprises a sheet main body 11 being installed in the mounting surface and having planar structure; a movement route of termites 12′ being formed in the sheet main body for movement of termites; and a layer of termite pesticide(not shown) comprising termite pesticide composition and being formed in the sheet main body and the movement route of termites 12′, wherein the movement route of termites 12′ is groove-like passage formed to be concave linearly on the sheet main body 11.

The groove-like passage is formed as a shape of groove on the sheet main body 11 which is produced with paper such as traditional Korean paper. There is no limitation of method of producing the groove-like passage, but following forming method can be used as a representative method.

For example, the method comprises adding Bistrifluron to alcohol as solvent to make solution of 2 w/v % concentration, dipping the sheet main body into the solution, drying the sheet main body, applying adhesive to the sheet main body and thermoforming by press. Here, as heated mold (not shown) having projections for forming groove-like passage is installed on the press, the sheet main body 11 is pressed to form the groove-like passage.

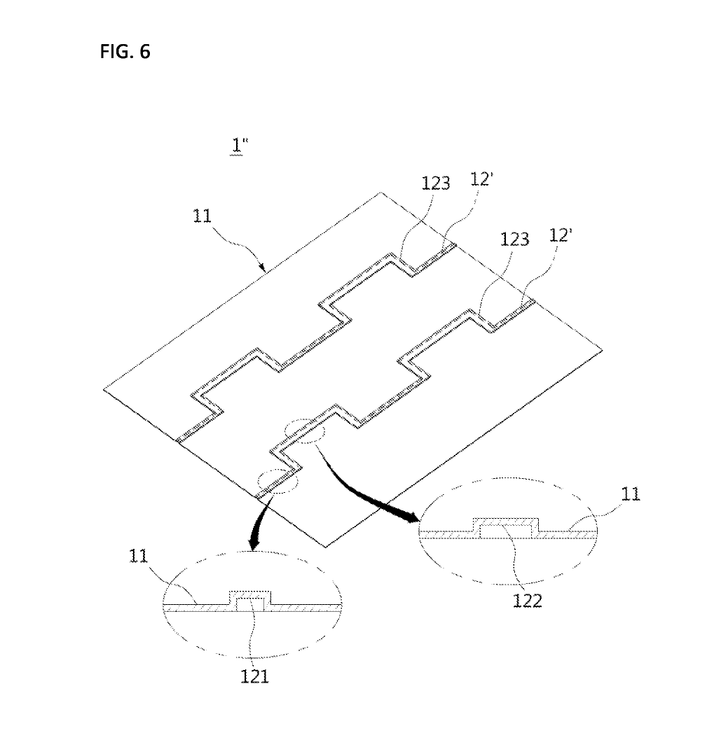

FIG. 6 is a perspective view of a sheet for controlling termites according to a modified embodiment of the present invention, and shows an enlarged cross-sectional view showing a schematic cross-sectional view of the indicated portion.

Referring to FIG. 6, the sheet for controlling termites 1″ according to a modified embodiment of the present invention comprises a sheet main body 11 having planar structure; and a movement route of termites 12′ for movement of termites, wherein the movement route of termites 12′ is groove-like passage formed to be concave linearly on the sheet main body, and the groove-like passage comprises a narrow passage 121 with narrow width and a wide passage 122 with wider width than the narrow passage.

In addition, the groove-like passage comprises more than one of bent portions 123 that allows termites to stay enough time within the planar body of the sheet main body although the sheet main body has limited space, and consequently large number of termites could be killed.

The groove-like passage of the sheet for controlling termites 1″ according to a modified embodiment of the present invention shown in FIG. 6 comprises a narrow passage 121 with narrow width and a wide passage 122 with wider width than the narrow passage. Therefore, it has an advantage in that various sizes of termites can be exposed or contact to the layer of termite pesticide and consequently the sheet improves efficiency of controlling termites.

In addition, the sheet for controlling termites is characterized in that as the groove-like passage is formed to have more than one of plural bent portions 123, it allows large number of termites to stay in the sheet for a long time, and consequently improves the control efficiency.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

The terms used in the above described embodiments are merely used to explain particular embodiments, and are not intended to limit the scope of the present invention. Unless having different meaning contextually, singular form of words include plural form of words, too. In this description, it should be understood that the words of “comprise” or “have” are used to include characteristic, number, step, operation, elements, parts or combination thereof, but aren't be used to in advance exclude the possibility of presence or addition of another characteristic, number, step, operation, elements, parts or combination thereof.

What is claimed is:

1. A sheet for controlling termites in order to remove termites characterized in comprising,
a sheet main body being installed on the mounting surface and having planar structure;
a movement route of termites being formed in the sheet main body for movement of termites; and
a layer of termite pesticide comprising termite pesticide composition and being formed in the sheet main body and the movement route of termites.

2. The sheet for controlling termites according to claim 1, wherein
the sheet main body consists of a planar body made of paper and fabric, and a linear member fixed to be placed on the planar body, and
the movement route of termites is the gap formed between the planar body and the linear member.

3. The sheet for controlling termites according to claim 2, wherein
the linear member consists of inorganic or organic fiber yarns, and is attached to the planar body by adhesive.

4. The sheet for controlling termites according to claim 1, wherein
the sheet main body is made of paper and fabric, and
the movement route of termites is groove-like passage formed to be concave linearly on the sheet main body.

5. The sheet for controlling termites according to claim 4, wherein
the groove-like passage comprises a narrow passage with narrow width and a wide passage with wider width than the narrow passage.

6. The sheet for controlling termites according to claim 4, wherein
the groove-like passage comprises more than one of bent portions.
